(19) United States
(12) Patent Application Publication
(10) Pub. No.: US 2025/0162865 A1
(43) Pub. Date: May 22, 2025

(54) APPARATUS AND METHOD FOR PROPORTIONAL INTEGRATION OF GREEN HYDROGEN IN DERIVATIVE PRODUCTION

(71) Applicant: ACWA POWER Company, Riyadh (SA)

(72) Inventor: Venkata Krishna VAKACHARLA, Dubai (AE)

(73) Assignee: ACWA POWER Company, Riyadh (SA)

(21) Appl. No.: 18/818,182

(22) Filed: Aug. 28, 2024

Related U.S. Application Data
(60) Provisional application No. 63/601,144, filed on Nov. 20, 2023.

(51) Int. Cl. C01B 3/02

(52) U.S. Cl. CPC C01B 3/025; C01B 2203/068

(57) ABSTRACT

An apparatus and method for proportional integration of green hydrogen in derivative production controls: (i) supply of green hydrogen from a hydrogen supply unit to a magnetite synthesis unit, and (ii) supply of first green nitrogen from an air supply unit to the magnetite synthesis unit. The apparatus monitors a temperature value of a first sub-unit of a set of sub-units based upon the supply of: (i) the first green nitrogen; and (ii) the green hydrogen. The apparatus compares the monitored temperature value of the first sub-unit with a first pre-determined temperature threshold value, and controls a supply of second green nitrogen from a nitrogen supply unit to the magnetite synthesis unit based upon a comparison that maintains a predefined ratio of nitrogen-to-hydrogen in the magnetite synthesis unit.

### CROSS-REFERENCE TO RELATED APPLICATION

This application claims priority to U.S. Provisional Patent Application Ser. No. 63/601,144, filed Nov. 20, 2023 and entitled APPARATUS AND METHOD FOR PROPORTIONAL INTEGRATION OF GREEN HYDROGEN FOR ENHANCED GREEN HYDROGEN DERIVATIVE PRODUCTION, the disclosure of which is incorporated herein by reference.

### TECHNOLOGICAL FIELD

The present disclosure generally relates to green hydrogen derivative plants, and more particularly relates to an apparatus and a method for proportional integration of green hydrogen in derivative production.

### BACKGROUND

Green hydrogen derivative plants are facilities that produce hydrogen and various hydrogen-based derivatives, such as methanol, ammonia, jet fuel, or other e-fuels, from renewable energy sources. These green hydrogen derivative plants are essential in decarbonizing hard-to-abate sectors like heavy industry, chemicals and materials, and heavy transportation, thereby supporting the development of a resilient future energy system. Further, steam methane reforming (SMR) is a traditional technique used for hydrogen production. For example, methane (for example, from natural gas) or hydrocarbons react with water (in the form of steam) at high temperatures (such as 700-1000 degrees Celsius) to produce hydrogen (H₂), carbon monoxide and a small amount of carbon dioxide, during the SMR process. Such a chemical reaction may take place in the presence of a catalyst such as a nickel-based catalyst. Further, optimization of hydrogen production and maintaining a nitrogen-to-hydrogen ratio in green hydrogen integration with existing hydrogen derivative plants through the SMR route have been long-standing challenges. Traditionally, various techniques and methods have been used to tackle this issue. The existing technique may be effective; however, they do not address the issue of maintaining an excess nitrogen-to-hydrogen ratio.

Currently, the hydrogen derivatives plant, which produces substances like ammonia and methanol, operates with a nitrogen-to-hydrogen ratio of less than 1:3 in the upstream process. When green hydrogen is introduced to produce green derivatives like ammonia in existing hydrogen derivative plants, a larger amount of nitrogen (N₂) is needed, which can only be fed by utilizing excess air, which is fed to a secondary reformer.

However, overutilizing the excess air to extract nitrogen leads to an oxygen-rich environment in multiple sections of the secondary reformer, which further leads to very high operating temperatures in some components of the plant and consequently reduces the lifespan of plant components. The limited syngas ratio (N₂:H₂<1:3) reduces the production capacity of the green hydrogen derivatives plant. The upstream plant struggles with excess nitrogen production for adequate syngas production, which is essential for downstream processes.

Therefore, there is a requirement for an apparatus that maintains a suitable environment for the production of green hydrogen derivatives in an integrated plant of green H₂ with existing hydrogen derivative plants for an effective, and efficient production of green hydrogen derivatives.

### BRIEF SUMMARY

The present invention discloses an apparatus and a method for proportional integration of green hydrogen in derivative production, thereby maintaining a suitable environment for the production of green hydrogen derivatives.

In one aspect, an apparatus for the proportional integration of green hydrogen in derivative production is provided. The apparatus may include at least one non-transitory memory configured to store computer-executable instructions and at least one processor to execute the computer-executable instructions. The processor may be configured to control a supply of green hydrogen from a hydrogen supply unit to a magnetite synthesis unit and control a supply of first green nitrogen from an air supply unit to the magnetite synthesis unit. The first green nitrogen may be extracted from the air. The processor may further be configured to monitor a temperature value of at least a first sub-unit of a set of sub-units based on the supply of the first green nitrogen from the air supply unit to the magnetite synthesis unit and the supply of the green hydrogen from the hydrogen supply unit to the magnetite synthesis unit. Thereafter, the processor may be configured to compare the monitored temperature value of at least the first sub-unit of the set of sub-units with a first pre-determined temperature threshold value and control a supply of second green nitrogen from a nitrogen supply unit to the magnetite synthesis unit based on the comparison, to maintain a predefined nitrogen-to-hydrogen ratio in the magnetite synthesis unit.

In additional apparatus embodiments, the set of sub-units may include a primary reformer unit, a secondary reformer unit, a shift and carbon dioxide removal unit, a methanation and dryer unit, a compression unit, the magnetite synthesis unit, a purge gas recovery unit, or a green hydrogen derivatives unit.

In additional apparatus embodiments, the processor may be configured to control the supply of the green hydrogen from the hydrogen supply unit to the magnetite synthesis unit based on the comparison to maintain the predefined ratio of the green nitrogen and the green hydrogen in the magnetite synthesis unit.

In additional apparatus embodiments, the processor may be configured to generate a feedback signal based on the comparison of the monitored temperature value with the first pre-determined temperature threshold value. The processor may be configured to control the supply of the green hydrogen from the hydrogen supply unit to the magnetite synthesis unit, the supply of the first green nitrogen from the air supply unit to the magnetite synthesis unit, and the supply of the second green nitrogen from the nitrogen supply unit to the magnetite synthesis unit based on the generated feedback signal.

In additional apparatus embodiments, the processor may be configured to control a proportion integrated controller (PIC) to receive the generated feedback signal. The air supply unit is integrated with the PIC.

In additional apparatus embodiments, the processor may be configured to be responsive to the monitored temperature value of at least the first sub-unit of the set of sub-units being greater than the first pre-determined temperature threshold value, control the supply of second green nitrogen from the nitrogen supply unit to the magnetite synthesis unit and control the supply of first green nitrogen from the air supply unit to the magnetite synthesis unit.

In additional apparatus embodiments, the processor may be configured to be responsive to the monitored temperature value of at least the first sub-unit of the set of sub-units being less than the first pre-determined temperature threshold value, control the supply of the second green nitrogen from the nitrogen supply unit to the magnetite synthesis unit and control the supply of the first green nitrogen from the air supply unit to the magnetite synthesis unit.

In additional apparatus embodiments, the hydrogen supply unit may correspond to an electrolyzer unit.

In additional apparatus embodiments, the processor may be configured to control the hydrogen supply unit to receive water and split the water into green hydrogen and green oxygen at an electrolyzing temperature.

In additional apparatus embodiments, the predefined ratio of green nitrogen to green hydrogen is 1:3.

In additional apparatus embodiments, the green nitrogen and the green hydrogen are used for the production of green ammonia. The green nitrogen and the green hydrogen are present in the predefined ratio.

In additional apparatus embodiments, the processor may be configured to regulate the ratio of the green nitrogen and the green hydrogen to match the predefined ratio in the magnetite synthesis unit using a proportion integrated controller (PIC).

In another aspect, a method for proportional integration of green hydrogen in derivatives production is disclosed. The method may include controlling a supply of green hydrogen from a hydrogen supply unit to a magnetite synthesis unit and controlling a supply of first green nitrogen from an air supply unit to the magnetite synthesis unit. The first green nitrogen may be extracted from the air. The method may further include monitoring a temperature value of at least a first sub-unit of a set of sub-units based on the supply of the first green nitrogen from the air supply unit to the magnetite synthesis unit and the supply of the green hydrogen from the hydrogen supply unit to the magnetite synthesis unit. The method may further include comparing the monitored temperature value of at least the first sub-unit of the set of sub-units with a first pre-determined temperature threshold value. The method may further include controlling a supply of second green nitrogen from a nitrogen supply unit to the magnetite synthesis unit based on the comparison, to maintain a predefined ratio of nitrogen-to-hydrogen in the magnetite synthesis unit.

In one method embodiment, the set of sub-units may include a primary reformer unit, a secondary reformer unit, a shift and carbon dioxide removal unit, a methanation and dryer unit, a compression unit, the magnetite synthesis unit, a purge gas recovery unit, or a green hydrogen derivatives unit.

In one method embodiment, the method includes controlling the supply of the green hydrogen from the hydrogen supply unit to the magnetite synthesis unit based on the comparison to maintain the predefined ratio of the green nitrogen and the green hydrogen in the magnetite synthesis unit.

In one method embodiment, the method includes generating a feedback signal based on the comparison of the monitored temperature value with the first pre-determined temperature threshold value. The method includes controlling the supply of green hydrogen from the hydrogen supply unit to the magnetite synthesis unit, the supply of the first green nitrogen from the air supply unit to the magnetite synthesis unit, and the supply of the second green nitrogen from the nitrogen supply unit to the magnetite synthesis unit based on the generated feedback signal.

In one method embodiment, the method includes controlling a proportion integrated controller (PIC) to receive the generated feedback signal. The air supply unit is integrated with the PIC.

In one method embodiment, the monitored temperature value of at least the first sub-unit of the set of sub-units is greater than the first pre-determined temperature threshold value, the method includes controlling the supply of the second green nitrogen from the nitrogen supply unit to the magnetite synthesis unit and controlling the supply of the first green nitrogen from the air supply unit to the magnetite synthesis unit.

In one method embodiment, the monitored temperature value of at least the first sub-unit of the set of sub-units is less than the first pre-determined temperature threshold value, the method includes controlling the supply of the second green nitrogen to terminate the supply of the second green nitrogen from the nitrogen supply unit to the magnetite synthesis unit and controlling the supply of the first green nitrogen to terminate the supply of the first green nitrogen from the air supply unit to the magnetite synthesis unit.

In yet another aspect, a non-transitory computer-readable medium having stored thereon, computer-executable instructions that when executed by a processor of an apparatus, cause the processor to execute operations. The operations may include controlling a supply of green hydrogen from a hydrogen supply unit to a magnetite synthesis unit and controlling a supply of first green nitrogen from an air supply unit to the magnetite synthesis unit, wherein the first green nitrogen is extracted from air. The first green nitrogen may be extracted from the air. The operations may further include monitoring a temperature value of at least a first sub-unit of a set of sub-units based on the supply of the first green nitrogen to the magnetite synthesis unit and the supply of the green hydrogen to the magnetite synthesis unit. The operations may further include comparing the monitored temperature value of at least the first sub-unit of the set of sub-units with a first pre-determined temperature threshold value. The operations may further include controlling a supply of second green nitrogen from a nitrogen supply unit to the magnetite synthesis unit based on the comparison, to maintain a predefined ratio of nitrogen-to-hydrogen in the magnetite synthesis unit.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 is a diagram that illustrates an exemplary block diagram of an apparatus for enhanced production of green hydrogen derivative plants, in accordance with an embodiment of the present disclosure;

FIG. 2 illustrates a block diagram of the apparatus of FIG. 1, in accordance with an embodiment of the disclosure;

FIG. 3 is an exemplary schematic diagram of the apparatus for the enhanced production of green hydrogen derivative plants, in accordance with an embodiment of the present disclosure;

FIG. 4 is a flowchart that illustrates an exemplary method for controlling the supply of green hydrogen, first green nitrogen and second green nitrogen, in accordance with an embodiment of the present disclosure; and

FIG. 5 is a flowchart that illustrates an exemplary method flowchart for the enhanced production of green hydrogen derivative plants, in accordance with an embodiment of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

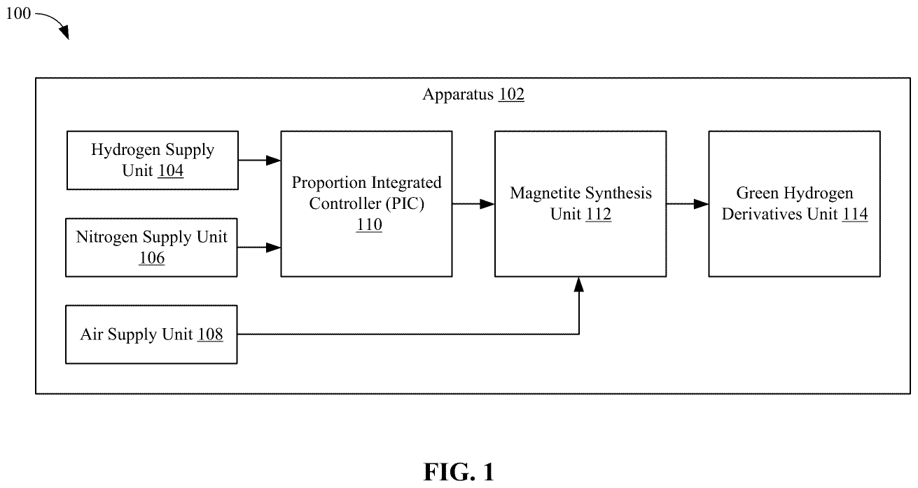

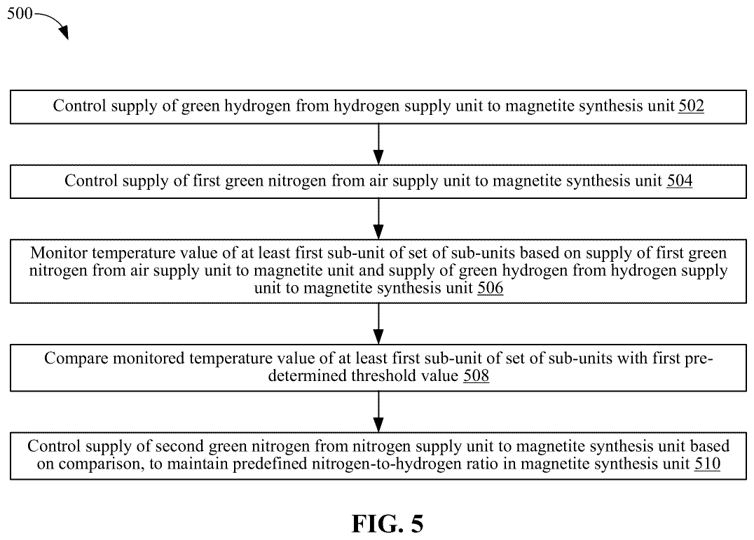

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1, to FIG. 5, a brief description concerning the various components of the present disclosure will now be briefly discussed.

Traditionally, hydrogen derivative plants operate with a nitrogen (N₂) to hydrogen (H₂) ratio of 1:3 in an upstream process. The upstream process may be referred to as a process that may take place in the initial stages of the production of the green hydrogen derivative plant. During the upstream process, excess N₂ is introduced to ensure that sufficient nitrogen is available for the derivative plants for integration of green H₂, the situation leads to the creation of an oxygen-rich environment in various sections of the upstream side of green hydrogen derivative plants. The presence of excess oxygen may lead to elevated operating temperatures, that, in turn, may have detrimental effects on the components of the existing H₂ derivative plant upstream sections. Further, the limited syngas (N₂:H₂) ratio, with nitrogen and hydrogen not being perfectly balanced, significantly reduces the production capacity of green hydrogen derivative plants.

In comparison with the traditional techniques, the current invention discloses an apparatus and a method for increasing the production of green hydrogen derivative plants. The apparatus may allow the supply of hydrogen and nitrogen in the required ratio to the green hydrogen derivative plant for an effective, and efficient production of green hydrogen derivatives. The proposed proportion integration system may monitor the temperatures of the components upstream in the green hydrogen derivative plant and control the nitrogen-to-hydrogen ratio to cool down the temperature of the components of the hydrogen derivative plant. The proposed method may utilize the full capacity of the green hydrogen derivative plant for enhanced production of the green hydrogen derivative plant.

FIG. 1 illustrates a diagram for an exemplary block diagram of an apparatus for enhanced production of hydrogen derivative plants, in accordance with an embodiment of the present disclosure. With reference to FIG. 1, there is shown the diagram 100 that may include an apparatus 102 that may be used for the production of green hydrogen derivatives such as, but not limited to, green ammonia. The apparatus 102 may include a hydrogen supply unit 104. The apparatus 102 may further include a nitrogen supply unit 106, an air supply unit 108, a proportion integrated controller (PIC) 110, a magnetite synthesis unit 112, and a green hydrogen derivatives unit 114.

The apparatus 102 may correspond to a green hydrogen derivative plant and may be used to produce hydrogen derivatives for example, but are not limited to, ammonia, methanol, hydrogen peroxide, synthetic fuels, and hydrogenated oils. The apparatus 102 may include multiple units and a set of sub-units that work collectively to produce the green hydrogen derivatives. Further, the apparatus 102 may include the proportion integrated controller 110. The proportion integrated controller 110 may be connected with the hydrogen supply unit 104 and the nitrogen supply unit 106. Further, the proportion integrated controller 110 may be responsible for controlling the supply of green nitrogen and green hydrogen from their respective sources into the magnetite synthesis unit 112.

The hydrogen supply unit 104 may be configured to produce green hydrogen from water (H₂O). The water (H₂O) may serve as the source of producing the green hydrogen through an electrolysis process in the hydrogen supply unit 104, which may be configured to produce hydrogen by electrolyzing water at an electrolyzing temperature (e.g., 85° C.). The hydrogen supply unit 104 may include an anode and a cathode that may be separated by an electrolyte. The electrolyzing temperature may be the temperature at which a molecule of water (H₂O) may be broken into one hydrogen (H₂) molecule and one oxygen atom. The hydrogen supply unit 104 may use electrolysis of water for the production of green hydrogen. The electrolysis may be a process that uses electricity to split water into hydrogen and oxygen. An electric current may be passed through the water to initiate different reactions (e.g., an oxidation reaction and/or a reduction reaction) at different electrodes (e.g., an anode and/or a cathode) of the hydrogen supply unit 104. For example, at the anode, the oxidation reaction may take place, causing the hydrogen supply unit 104 to produce oxygen. Further, at the cathode, the reduction reaction may take place, causing the hydrogen supply unit 104 to produce green hydrogen (H₂) in a gaseous form.

In an embodiment, the hydrogen supply unit 104 may include various electrolyzers, such as, but is not limited to, a polymer electrolyte membrane (PEM) electrolyzer, which may use a solid polymer electrolyte and operate efficiently at lower temperatures, an alkaline electrolyzer, which may be cost-effective, and suitable for large-scale hydrogen production using an alkaline solution as the electrolyte, and solid oxide electrolyzers, which may operate at high temperatures and provide high efficiency with the ability to co-electrolyze water and carbon dioxide.

In an embodiment, the air supply unit 108 may be configured to extract the first green nitrogen from ambient air and compress the first green nitrogen to the required pressure levels, making it suitable for use in the apparatus 102. Further, the air supply unit 108 may be configured to remove dust, particulates, and other contaminants from the air to ensure that only clean, high-quality air is used in the synthesis processes. For example, the air supply unit 108 may be designed to operate continuously, thereby ensuring a constant and reliable supply of air. The air supply unit 108 may include advanced sensors and control systems to monitor the pressure, flow rate, and purity of the air, providing real-time data to the proportion integrated controller 110. Further, the air supply unit 108 may include but is not limited to, air compressors, filtration systems, and storage tanks. The air supply unit 108 may include safety features, such as pressure relief valves and emergency shutdown mechanisms, to protect the apparatus 102 from overpressure and other potential hazards.

The apparatus 102 may further include the nitrogen supply unit 106 which may be connected to the proportion integrated controller 110. The nitrogen supply unit 106 may be configured to supply a second green nitrogen from the nitrogen supply unit 106 to the magnetite synthesis unit 112. Further, the nitrogen supply unit 106 may correspond to a storage unit for the second green nitrogen that may be produced using various green nitrogen generation procedures known in the art. Such green nitrogen generation procedures may correspond to processes such as, but not limited to, air separation process, and membrane separation process.

The apparatus 102 may further include the proportion integrated controller 110. The proportion integrated controller 110 may be equipped with advanced control algorithms and real-time monitoring capabilities, thereby allowing for dynamic adjustment of the flow rates and proportions of supply of the green hydrogen, the first green nitrogen, and the second green nitrogen. This may facilitate the nitrogen-to-hydrogen ratio to remain within a desired range, which is critical for the efficient synthesis of green hydrogen derivatives. The proportion integrated controller 110 may receive input data from one or more sensors installed in the hydrogen supply unit 104, the nitrogen supply unit 106, and the air supply unit 108. Examples of the input data may include but are not limited to, a flow rate of the green hydrogen, a pressure level of green hydrogen, a temperature of the green hydrogen, a flow rate of the green nitrogen, a pressure level of green nitrogen, a temperature of the green nitrogen and gas purity. The input data may facilitate the proportion integrated controller 110 to continuously determine the optimal supply ratio of green hydrogen and green nitrogen. Further, control valves may be adjusted to regulate gas supplies (such as a hydrogen gas supply, a nitrogen gas supply, and the like) based on the determined optimal supply ratios. In addition to regulating the gas supplies, the proportion integrated controller 110 monitors the performance of the magnetite synthesis unit 112 and the green hydrogen derivatives unit 114, thereby ensuring that the magnetite synthesis unit 112 and the green hydrogen derivatives unit 114 operate under optimal conditions.

The magnetite synthesis unit 112 may be configured to process the integrated inputs from the hydrogen supply unit 104, the nitrogen supply unit 106, and the air supply unit 108 to synthesize magnetite, which is an essential intermediate for the production of green hydrogen derivatives. The magnetite synthesis unit 112 may operate under carefully controlled conditions, with specific temperature and pressure settings required to facilitate the chemical reactions that produce magnetite. The magnetite synthesis unit 112 may include reactors where these chemical reactions may occur, along with heat exchangers and catalysts to optimize the process. Further, the reactors may be designed to ensure thorough mixing of the inputs and efficient contact with the catalysts, which accelerate the rate of the chemical reaction. The magnetite synthesis unit 112 also includes monitoring systems to track the temperature, pressure, and composition of the reaction mixture, providing data to the proportion integrated controller 110 for real-time adjustments. By ensuring that the reaction conditions are maintained within the optimal range, the magnetite synthesis unit 112 maximizes the yield and purity of the magnetite produced. The synthesized magnetite is then directed to the green hydrogen derivatives unit 114 for further processing.

The green hydrogen derivatives unit 114 may be connected to the magnetite synthesis unit 112. The green hydrogen derivatives unit 114 may receive a gas mixture containing desired green nitrogen, and green hydrogen in a ratio like 1:3. The green hydrogen derivatives unit 114 may contain the derivatives of green hydrogen, such as, but is not limited to, green ammonia and methanol. The green hydrogen derivatives unit 114 may include advanced catalysts that enhance the reaction rates and selectivity, ensuring that the maximum amount of product is generated from the available inputs.

In operation, the apparatus 102 is configured to control the supply of green hydrogen from the hydrogen supply unit 104 to the magnetite synthesis unit 112. For example, the proportion integrated controller 110 may be configured to control the supply of green hydrogen into the magnetite synthesis unit 112. The proportion integrated controller 110 may be configured to adjust the supply of the green hydrogen based on the requirements of the magnetite synthesis process, thereby ensuring an optimal nitrogen-to-hydrogen ratio for efficient synthesis of green hydrogen derivatives. For example, the optimal nitrogen-to-hydrogen ratio may be 1:3.

Further, the apparatus 102 may be configured to control the supply of first green nitrogen from the air supply unit 108 to the magnetite synthesis unit 112. The first green nitrogen may be extracted from the air. For example, the air supply unit 108 may utilize processes, such as, but not limited to, cryogenic distillation or pressure swing adsorption (PSA) to separate green nitrogen from the air. For example, the cryogenic distillation process involves cooling air to extremely low temperatures to liquefy the air, followed by the separation of green nitrogen based on its boiling point. For example, pressure swing adsorption utilizes adsorbent materials that preferentially capture the green nitrogen under high pressure and release it when the pressure is reduced. These processes may lead to an increase in the temperature of the apparatus 102. Further, apparatus 102 may be configured to control the supply of the green nitrogen into the magnetite synthesis unit 112 from the air supply unit 108. The first green nitrogen is then supplied to the magnetite synthesis unit 112 under the control of the proportion integrated controller 110.

Further, the apparatus 102 may be configured to monitor a temperature value of at least a first sub-unit of a set of sub-units based on the supply of the first green nitrogen and the supply of the green hydrogen. For example, the apparatus 102 may continuously monitor the temperature value of at least one sub-unit, by utilizing sensors attached to each of the set of sub-units. Such sensors may provide real-time temperature values of each of the set of sub-units based on the supply of green hydrogen and the supply of the first green nitrogen.

Further, the apparatus 102 may be configured to compare the monitored temperature value of at least the first sub-unit of the set of sub-units with a first pre-determined temperature threshold value. For example, the first pre-determined temperature threshold value for the air supply unit 108 to function efficiently may be close to 1000 degrees Celsius. In another example, the first pre-determined temperature threshold value for the magnetite synthesis unit 112 to function efficiently may be close to 1200 degrees Celsius. In an example, the proportion integrated controller 110 may compare the temperature of each of the set of sub-units with a first pre-determined temperature threshold value for each of the set of sub-units. Thereafter, the apparatus 102 may be configured to control a supply of the second green nitrogen from the nitrogen supply unit 106 to the magnetite synthesis unit 112 based on the comparison, to maintain a predefined nitrogen-to-hydrogen ratio.

Traditionally, in the green hydrogen derivative plants, chemicals such as, but not limited to, green ammonia and methanol may be produced. Further, the green hydrogen derivative plants may operate with a nitrogen-to-hydrogen ratio of less than 1:3 in an upstream process. Further, such a low ratio (for example, less than 1:3) of the nitrogen to hydrogen may lead to very high operating temperatures and consequently reduce the lifespan of one or more components of the green hydrogen derivative plant. To overcome this issue, the present disclosure may integrate the proportion integrated controller 110 within the apparatus 102 to maintain the temperature of one or more sub-units of a set of sub-units of the green hydrogen derivative plant, thereby maintaining the nitrogen-to-hydrogen ratio for an efficient operation of the green hydrogen derivative plant.

In an example, the second green nitrogen from the nitrogen supply unit 106 may be supplied to the magnetite synthesis unit 112 when the ratio of the first green nitrogen to hydrogen falls below the predefined ratio or when the temperature of at least one of the set of sub-units (such as the first sub-unit) exceeds the corresponding pre-determined threshold value. This may facilitate that the nitrogen-to-green hydrogen ratio remains within the desired ratio. For example, the desired ratio may be 1:3 for the production of green ammonia. The proportion integrated controller 110 may continually monitor the nitrogen-to-green hydrogen ratio and may control the supply of the second green nitrogen from the nitrogen supply unit 106. For example, where the monitored ratio deviates from the desired level. In another embodiment, the proportion integrated controller 110 may control the supply of the second green nitrogen from the nitrogen supply unit 106 to ensure that the upstream processes of the apparatus 102 may remain under the desired temperature limit.

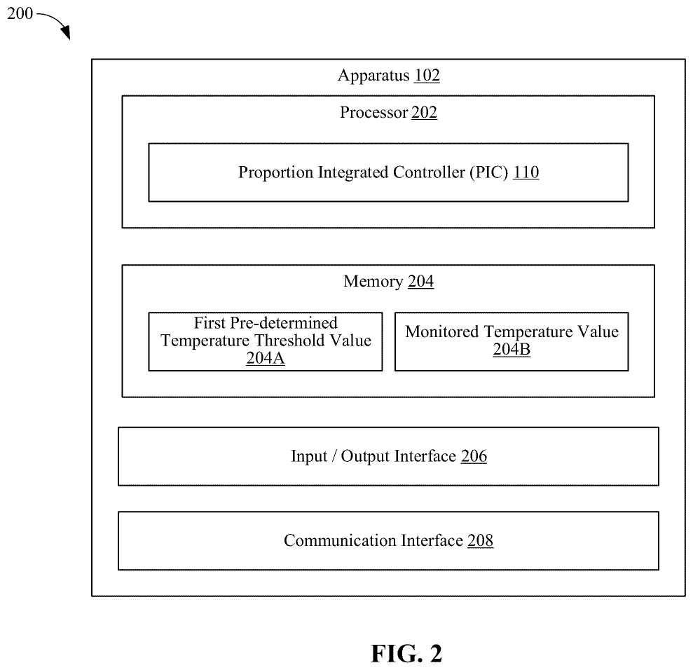

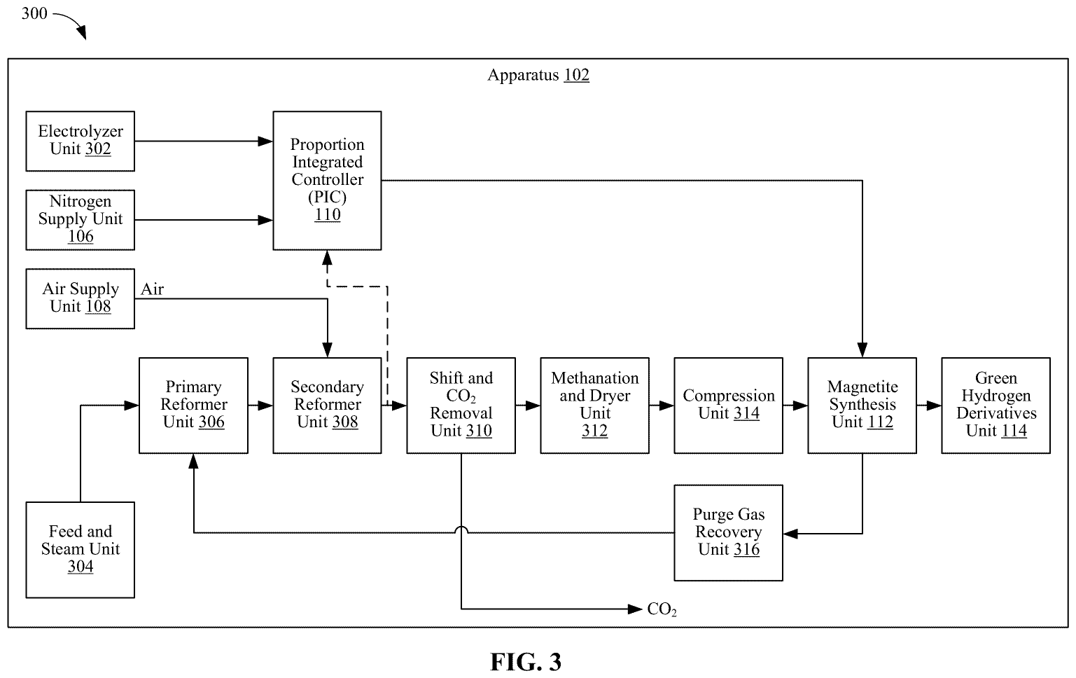

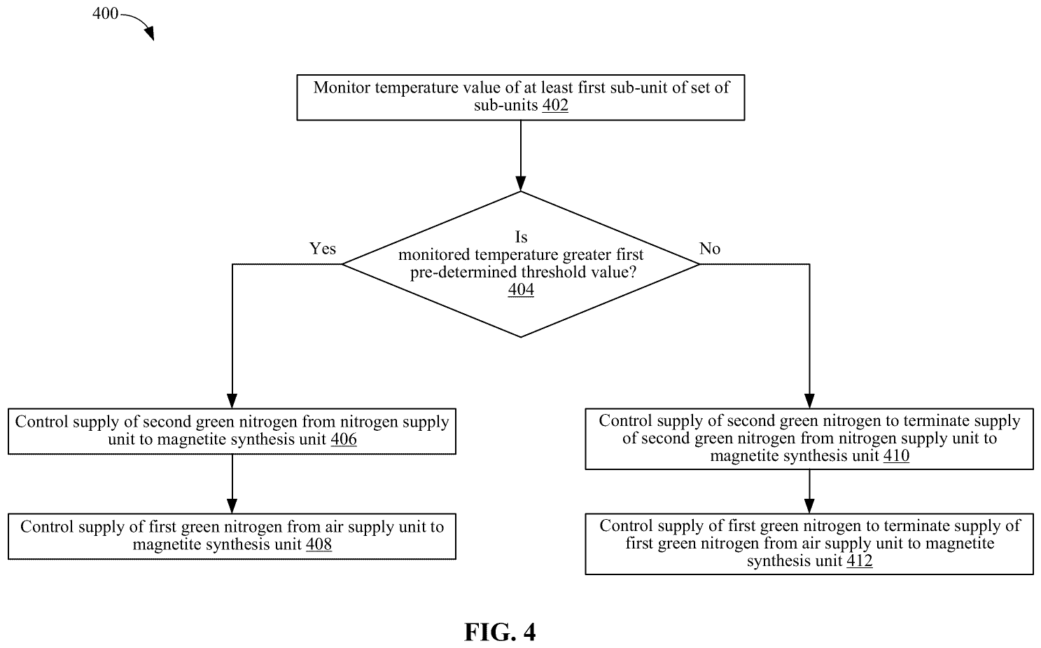

In some embodiments, the apparatus 102 includes additional components for proportional integration of green hydrogen for the enhanced green hydrogen derivative production. These components are further shown in conjunction with FIG. 2, FIG. 3, FIG. 4, and FIG. 5.

FIG. 2 illustrates a block diagram 200 of the apparatus 102 of FIG. 1, in accordance with an embodiment of the disclosure. FIG. 2 is explained in conjunction with FIG. 1. In FIG. 2, there is shown the block diagram 200 of the apparatus 102. The apparatus 102 may include at least one processor 202 (referred to as a processor 202, hereinafter), at least one non-transitory memory 204 (referred to as a memory 204, hereinafter), an input/output (I/O) interface 206, and a communication interface 208. The processor 202 may be connected to the memory 204, the I/O interface 206, and the communication interface 208 through one or more wired or wireless connections. Although in FIG. 2, it is shown that the apparatus 102 includes the processor 202, the memory 204, the I/O interface 206, and the communication interface 208 however, the disclosure may not be so limiting and the apparatus 102 may include fewer or more components to perform the same or other functions of the apparatus 102.

The processor 202 of the apparatus 102 may be configured to control the proportion integration system required by the green hydrogen derivative plant for enhanced hydrogen derivative production. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the apparatus 102.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The communication interface 208 may provide an interface for accessing various features and data stored in the memory 204.

The processor 202 of the apparatus 102 may further include the proportion integrated controller 110. The proportion integrated controller 110 plays an important role in optimizing and enhancing the production of green hydrogen derivative plants. The proportion integrated controller 110 may efficiently manage the desired green nitrogen to green hydrogen ratio. The proportion integrated controller 110 integrated with the apparatus 102 may monitor critical parameters within the green hydrogen derivative plant. For example, the proportion integrated controller 110 associated with the processor 202 may monitor oxygen concentration in the green hydrogen derivative plant, and the proportion integrated controller 110 may further monitor the temperature of at least the first sub-unit of the set of sub-units. The set of sub-units may be different from the hydrogen supply unit and the nitrogen supply unit 106. The hydrogen supply unit may correspond to the hydrogen supply unit 104. The proportion integrated controller 110 may control the green nitrogen-to-green hydrogen ratio that may further help the green hydrogen plant operate efficiently and may help produce the required green hydrogen derivative such as, but not limited to, green ammonia.

In an embodiment, the proportion integrated controller (PIC) 110 may be configured to receive a feedback signal. In one embodiment, the apparatus may be configured to generate a feedback signal based on the comparison of the monitored temperature value 204B with the first pre-determined temperature threshold value 204A. The feedback signal may be utilized to control the supply of the second green nitrogen from the nitrogen supply unit, the supply of the first nitrogen from the air supply unit, and the supply of green hydrogen from the hydrogen supply unit to the magnetite synthesis unit 112. The generated feedback signal after being received by the PIC 110 control may indicate a condition when the monitored temperature value 204B of the first sub-unit of the set of sub-units may be greater than the first pre-determined temperature threshold value 204A.

In another embodiment, the proportion integrated controller (PIC) 110 may further be configured to cause the apparatus 102 to control the supply of green hydrogen from the hydrogen supply unit 104 based on the comparison of the monitored temperature value 204B of the first sub-unit of the set of sub-units to maintain a predefined nitrogen-to-hydrogen ratio. The predefined nitrogen-to-hydrogen ratio may be, but is not limited to, 1:3.

In an exemplary embodiment, the proportion integrated controller (PIC) 110 may be used to control the supply of the second green nitrogen from the nitrogen supply unit 106 to maintain the predefined ratio of 1:3 in a condition when the monitored temperature value 204B is greater than the first pre-determined temperature threshold value 204A. By obtaining the predefined green nitrogen to green hydrogen ratio, the temperature of the set of sub-units may drop to the desired level, and the proportion integrated controller 110 may control the supply of green nitrogen from the nitrogen supply unit 106 into the magnetite synthesis unit 112.

In another embodiment, the proportion integrated controller (PIC) 110 may further be used to regulate the ratio of nitrogen and green hydrogen to the predefined nitrogen to hydrogen ratio. For example, the proportion integrated controller (PIC) may be used to efficiently manage the desired green nitrogen to green hydrogen ratio by supplying the green hydrogen and the green nitrogen. The proportion integrated controller 110 may control the green nitrogen to the green hydrogen ratio which may further help the green hydrogen plant operate efficiently and may help produce the required green hydrogen derivative such as, but not limited to, green ammonia.

The memory 204 may be non-transitory and may include, for example, one or more volatile and/or non-volatile memories. In other words, for example, the memory 204 may be an electronic storage device (for example, a computer-readable storage medium) comprising gates configured to store data (for example, bits) that may be retrievable by a machine (for example, a computing device like the processor 202). The memory 204 may be configured to store information, data, content, applications, instructions, or the like, for enabling the apparatus 102 to carry out various functions in accordance with an example embodiment of the present disclosure. For example, the memory 204 may be configured to buffer input data for processing by the processor 202. As exemplified in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an Application Specific Integrated Circuit (ASIC), Field Programmable Gate Array (FPGA), or the like, the processor 202 may be specifically configured hardware for conducting the operations described herein. In an embodiment, memory may be configured to store a first pre-determined temperature threshold value 204A of each of the set of sub-units and a monitored temperature value 204B of each of the set of sub-units.

The first pre-determined temperature threshold value 204A of each of the set of sub-units may be a collection of temperatures that may be carefully determined and pre-set based on the operational characteristics of each of the set of sub-units. For example, the first pre-determined temperature threshold value 204A of the apparatus 102 at the primary reformer unit may be 810 degrees Celsius. In one more example, the first pre-determined temperature threshold value 204A of the apparatus 102 at the secondary reformer unit maybe 1000 degrees Celsius.

In one embodiment, the monitored temperature value 204B of each of the set of sub-units may be stored in the memory 204. The proportion integrated controller 110 in the apparatus 102 may monitor the temperatures of each of the set of sub-units in the green hydrogen derivative plant. By storing an accurate record of the monitored temperature value 204B of each of the set of sub-units in the memory 204, the proportion integrated controller 110 may enable real-time adjustments to keep the set of sub-units within the ideal operating temperature ranges. The proportion integrated controller 110 associated with the processor 202 may be configured to compare the monitored temperature value 204B of each of the set of sub-units with the first pre-determined temperature threshold value 204A for each of the set of sub-units.

In an exemplary embodiment, based on the monitored temperature value 204B of the at least the first sub-unit of the set of sub-units being greater than the first pre-determined temperature threshold value 204A, the proportion integrated controller 110 may start the supply of the green nitrogen from the nitrogen supply unit 106 into the magnetite synthesis unit 112. The supply of the green nitrogen from the nitrogen supply unit 106 may continue till the green nitrogen to green hydrogen ratio comes to a desired level of 1:3.

In one embodiment, the first pre-determined temperature threshold value 204A of each of the set of sub-units may be stored in the memory 204. In the green hydrogen derivative plant, maintaining the correct operating temperatures for the set of sub-units is essential for efficient and effective operations for the production of green hydrogen derivatives. As discussed above, the set of sub-units may correspond to a primary reformer unit, the secondary reformer unit, a shift and carbon dioxide removal unit, a methanation and dryer unit, a compression unit, and a purge gas recovery unit. Details for the set of sub-units are described, for example, in FIG. 3.

In some example embodiments, the I/O interface 206 may communicate with the apparatus 102 and display the input and/or output of the apparatus 102. As such, the I/O interface 206 may include a display and, in some embodiments, may also include a keyboard, a mouse, a touch screen, touch areas, soft keys, or other input/output mechanisms. In one embodiment, the apparatus 102 may include a user interface circuitry configured to control at least some functions of one or more I/O interface elements such as a display and, in some embodiments, a plurality of speakers, a ringer, one or more microphones and/or the like. The processor 202 and/or the I/O interface 206 circuitry comprising the processor 202 may be configured to control one or more functions of one or more I/O interface 206 elements through computer program instructions (for example, software and/or firmware) stored on a memory 204 accessible to the processor 202.

The communication interface 208 may comprise an input interface and output interface for supporting communications to and from the apparatus 102 or any other component with which the apparatus 102 may communicate. The communication interface 208 may be any means such as a device or circuitry embodied in either hardware or a combination of hardware and software that is configured to receive and/or transmit data to/from a communications device in communication with the apparatus 102. In this regard, the communication interface 208 may include, for example, an antenna (or multiple antennae) and supporting hardware and/or software for enabling communications with a wireless communication network. Additionally, or alternatively, the communication interface 208 may include the circuitry for interacting with the antenna(s) to cause transmission of signals via the antenna(s) or to handle receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB), or other mechanisms.

FIG. 3 is an exemplary schematic diagram 300 of the apparatus 102 for the enhanced production of green hydrogen derivative plants, in accordance with an embodiment of the present disclosure. FIG. 3 is explained in conjunction with elements from FIG. 1, and FIG. 2. With reference to FIG. 3, there is shown the schematic diagram 300 that may include an apparatus 102 which may be used for the production of the green hydrogen derivatives such as, but is not limited to, green ammonia.

The apparatus 102 may include an electrolyzer unit 302, the nitrogen supply unit 106, the air supply unit 108, the proportion integrated controller 110, the magnetite synthesis unit 112, and the green hydrogen derivatives unit 114. The apparatus may further include a feed and steam unit 304, a primary reformer unit 306, a secondary reformer unit 308, a shift and carbon dioxide removal unit 310, a methanation and dryer unit 312, a compression unit 314, and a purge gas recovery unit 316.

In one embodiment, the electrolyzer unit 302 may correspond to the hydrogen supply unit 104. The electrolyzer unit 302 may be configured to receive water and split the water into green hydrogen and green oxygen at an electrolyzing temperature to produce the green hydrogen. Further, the green hydrogen may be supplied to the magnetite synthesis unit 112. The electrolyzer unit 302 may include a large tank or container that houses the electrolysis process. The electrolyzer unit 302 may be designed to operate efficiently and safely, with features such as temperature control and pressure management. Further, the electrolyzer unit 302 may be equipped with sensors and monitoring systems to ensure optimal performance and detect any potential issues.

The apparatus 102 may further include the nitrogen supply unit 106, the air supply unit 108, and the proportional integrated controller 110. The air supply unit 108 may be used to provide air to the secondary reformer unit 308. Further, the secondary reformer unit 308 may utilize the air from the air supply unit 108 to produce the first green nitrogen. The produced first green nitrogen may be then supplied to the magnetite synthesis unit 112 for further processing. The nitrogen supply unit 106 may be the storage unit for the second green nitrogen which may be supplied into the magnetite synthesis unit 112. The supply of the green hydrogen from the electrolyzer unit 302, and the second green nitrogen from the nitrogen supply unit 106 may be controlled by the proportional integrated controller 110 for maintaining the desired ratio of green nitrogen-to-green hydrogen in the magnetite synthesis unit 112.

The apparatus 102 may further include the feed and steam unit 304. The feed and steam unit 304 may be connected to the primary reformer unit 306. Further, the feed and steam unit 304 may provide feedstock, typically a hydrocarbon source such as, but not limited to, natural gas and steam required by the primary reformer unit 306. The hydrocarbon feedstock may serve as a source of carbon for reforming reactions. Further, the steam may be used to facilitate the conversion of the hydrocarbons into hydrogen and carbon monoxide. The operation of the feed and steam unit 304 may ensure a continuous and reliable supply of reactants to the primary reformer unit 306, thereby contributing to the overall efficiency of the hydrogen generation and subsequent green hydrogen derivative production.

In an embodiment, the primary reformer unit 306 may be responsible for an initial generation of green hydrogen. The green hydrogen may be generated by subjecting the hydrocarbon feedstock, often the natural gas, to high temperatures and the steam in a catalytic reaction known as steam methane reforming. Such a chemical reaction may produce a mixture of hydrogen (H₂) and carbon monoxide (CO). The source for hydrocarbon feedstock and the steam required for elevating the temperatures to produce hydrogen in the primary reformer unit 306 may be the feed and steam unit 304.

In an embodiment, the secondary reformer unit 308 may be connected to the primary reformer unit 306 and the air supply unit 108. The secondary reformer unit 308 may receive the first green nitrogen from the air supply unit 108. In an embodiment, the air may be introduced into the secondary reformer unit 308 to create necessary conditions for subsequent chemical reactions for the production of the green ammonia (NH₃). The secondary reformer unit 308 may facilitate additional reforming reactions by using a catalyst. Such chemical reactions may involve the combination of the green nitrogen and the green hydrogen. The green hydrogen may be obtained from the primary reformer unit 306 to form the hydrogen derivatives such as ammonia and adjust the nitrogen-to-hydrogen ratio to the predefined nitrogen-to-hydrogen ratio.

The apparatus 102 may further include the shift and carbon dioxide removal unit 310. The shift and carbon dioxide removal unit 310 may be critical for refining the gas mixture obtained from the secondary reformer unit 308. The shift and carbon dioxide removal unit 310 may be connected to the secondary reformer unit 308 and may intake the gas mixture from the secondary reformer unit 308 as an input. The gas mixture may include the hydrogen and the nitrogen from the secondary reformer unit 308. Thereafter, the gas mixture may be directed to the shift and carbon dioxide removal unit 310.

In one embodiment, the gas mixture received from the secondary reformer unit 308 may undergo a shift reaction in the shift and carbon dioxide removal unit 310. For example, the shift reaction may correspond to a water-gas shift reaction. The shift reaction may involve a conversion of carbon monoxide (CO) and water (H₂O) to produce additional hydrogen and carbon dioxide (CO₂) This shift reaction may increase the hydrogen content in the gas mixture and reduce the carbon monoxide concentration.

In another embodiment, after the shift reaction takes place, the gas mixture produced may contain an increased amount of carbon dioxide (CO₂). To enhance the purity of the gas mixture, the gas mixture may undergo a carbon dioxide removal process in the shift and carbon dioxide removal unit 310. For example, an amine absorption method may be applied to selectively capture and remove carbon dioxide from the gas mixture. The output of the shift and carbon dioxide removal unit 310 may be a purified gas mixture enriched in hydrogen and with less concentration of carbon monoxide and carbon dioxide. The output of the shift and carbon dioxide removal unit 310 may enter the methanation and dryer unit 312.

In one embodiment, the gas mixture from the shift and carbon dioxide removal unit 310 enriched in hydrogen containing some residuals of carbon oxides (CO and CO₂) may enter a methanation reactor present in the methanation and dryer unit 312. In the methanation reactor, a methanation reaction may occur where hydrogen may react with carbon oxides to produce methane (CH₄). The methanation reaction may help reduce the concentration of carbon oxides, further enhancing the purity of the hydrogen-rich gas.

In another embodiment, the gas mixture that may leave the methanation reactor present in the methanation and dryer unit 312 may contain a certain amount of moisture. The one or more drying units present within the methanation and dryer unit 312 may remove such moisture from the gas mixture. Further, the one or more dying agents may absorb the water, thereby ensuring the gas is dry and ready to enter the next stage of the apparatus 102 which may be the compression unit 314.

The compression unit 314 may receive the gas mixture from the methanation and dryer unit 312. Further, the compression unit 314 may increase the pressure of the gas mixture. For example, the green hydrogen and the green nitrogen may be required at elevated pressures for efficient downstream processes. In an example, the compression unit 314 may include one or more compressors to raise the pressure of the gas mixture to the desired level. For example, the desired pressure of the gas mixture may be 155 bars. The compressed gas from the compression unit 314 may enter the magnetite synthesis unit 112 for further processing.

In an embodiment, the compression unit 314 may be connected to the magnetite synthesis unit 112. The magnetite synthesis unit 112 may take the compressed gas mixture from the compression unit 314 as an input. The magnetite synthesis unit 112 may be further connected to the purge gas recovery unit 316. In the magnetite synthesis unit 112, a magnetite synthesis reaction may take place. For example, iron oxide may react with hydrogen to produce magnetite (FeO₄). The produced magnetite may be sourced to the purge gas recovery unit 316. Further, the magnetite nanoparticles have been shown to exhibit high catalytic activity in certain chemical reactions, which could be useful in the production of green hydrogen derivatives.

The apparatus 102 may further include the purge gas recovery unit 316. The purge gas recovery unit 316 may be connected to the magnetite synthesis unit 112 and may intake as input the unreacted gases or by-products from the magnetite synthesis unit 112. The purge gas recovery unit 316 may recover and recycle the unreacted gases. The purge gas recovery unit 316 may be further connected to the primary reformer unit 306 and the compression unit 314. The purge gas recovery unit may source the hydrocarbons formed in the magnetite synthesis unit 112 to the primary reformer unit 306. The purge gas may act as a fuel required by the primary reformer unit 306 for the catalytic reaction, making the hydrogen derivative production more efficient and optimized.

The apparatus 102 may further contain green hydrogen derivatives unit 114. The green hydrogen derivatives unit 114 may be connected to magnetite synthesis unit 112. The green hydrogen derivatives unit 114 may receive a gas mixture containing desired green nitrogen to green hydrogen & grey hydrogen with a ratio like 1:3. The green hydrogen derivatives unit 114 may contain the derivatives of green hydrogen such as, but is not limited to, green ammonia, methanol or synthetic fuels. These derivatives may be used as a low-carbon alternative to fossil fuels in various industries such as transportation, agriculture, or manufacturing. For example, the green ammonia may be produced using green hydrogen and nitrogen may serve as a carbon-free fertilizer, a hydrogen energy carrier, or a feedstock for the production of green methanol.

During the production of green hydrogen derivatives, the upstream processes in the hydrogen derivatives plant may create an oxygen-rich environment due to the imbalance in the green nitrogen to green hydrogen ratio. The oxygen-rich environment may increase the temperature of the set of sub-units present in the apparatus 102. This may lead to reducing the lifespan of the set of sub-units present in the apparatus 102. The set of sub-units may correspond to the primary reformer unit 306, the secondary reformer unit 308, the shift and the shift and carbon dioxide removal unit 310, the methanation and dryer unit 312, the compression unit 314, and the purge gas recovery unit 316.

To maintain the temperature of the set of sub-units present in the apparatus 102, the present disclosure may integrate the proportion integrated controller 110 within the apparatus 102, thereby maintaining the nitrogen-to-hydrogen ratio for an efficient operation of the green hydrogen derivative plant. In an embodiment, the apparatus 102 may be configured to balance the supply of first green nitrogen from the air supply unit 108 and the second green nitrogen from the nitrogen supply unit 106 to the magnetite synthesis unit 112 based on the temperature of each of the sub-units which is further explained in detail in FIG. 4.

FIG. 4 is a flowchart 400 that illustrates an exemplary method for controlling the supply of the green hydrogen, the first green nitrogen, and the second green nitrogen, in accordance with an embodiment of the disclosure. FIG. 4 is explained in conjunction with elements from FIG. 1, FIG. 2, and FIG. 3. With reference to FIG. 4, there is shown the flowchart 400. The operations of the exemplary method may be executed by an apparatus, for example, the apparatus 102 of FIG. 1 or the processor 202 of FIG. 2. The operations of the flowchart 400 may start at 402.

At 402, a temperature value of at least a first sub-unit of the set of sub-units may be monitored based on the supply of the first green nitrogen from the air supply unit 108 to the magnetite synthesis unit 112 and the supply of the green hydrogen from the air supply unit 108 to the magnetite synthesis unit 112. In an embodiment, the processor 202 may be configured to monitor the temperature value of at least the first sub-unit of the set of sub-units based on the supply of the first green nitrogen from the air supply unit 108 to the magnetite synthesis unit 112 and the supply of the green hydrogen from the air supply unit 108 to the magnetite synthesis unit 112. For example, the processor 202 may be equipped with sensors to measure the temperature of each sub-unit of the set of sub-units. Such monitoring may be essential for maintaining optimal operating conditions, as it provides real-time data that informs subsequent control actions. The monitored temperature value 204B may form the basis for determining whether any adjustments are necessary to maintain the efficiency and safety of the overall process of hydrogen generation and subsequent green hydrogen derivative production.

At 404, the monitored temperature value 204B of at least the first sub-unit of the set of sub-units may be compared with the first pre-determined temperature threshold value 204A. In an embodiment, the processor 202 may be configured to compare the monitored temperature value 204B of at least the first sub-unit of the set of sub-units with the first pre-determined temperature threshold value 204A. In an embodiment, the first pre-determined temperature threshold value 204A may represent the maximum allowable temperature for safe and efficient operation of the first sub-unit. If the monitored temperature value 204B exceeds or is equal to the first pre-determined temperature threshold value 204A, it indicates that the apparatus 102 may be overheating, and corrective measures are necessary to bring the temperature back within the safe range. If the monitored temperature value 204B is greater than or equal to the first pre-determined temperature threshold value 204A, the control may pass to 406. On the contrary, if the monitored temperature value 204B is less than the first pre-determined temperature threshold value 204A, the control may pass to 410.

At 406, the supply of second green nitrogen from the nitrogen supply unit 106 to the magnetite synthesis unit 112 may be controlled. In an embodiment, the processor 202 may be configured to control the supply of second green nitrogen from the nitrogen supply unit 106 to the magnetite synthesis unit 112 based on the comparison. For example, the processor 202 may be configured to increase the supply of the second green nitrogen from the nitrogen supply unit 106 to decrease the temperature of the first sub-unit of the set of sub-units. Such a decrease in the temperature of the set of sub-units present in the apparatus 102 may lead to a decrease in the oxygen-rich environment, thereby increasing the lifespan of the set of sub-units present in the apparatus 102.

At 408, the supply of first green nitrogen from the air supply unit 108 to the magnetite synthesis unit 112 may be controlled. In an embodiment, the processor 202 may be configured to control the supply of first green nitrogen from the air supply unit 108 to the magnetite synthesis unit 112. In an example, the supply of first green nitrogen from the air supply unit 108 may be decreased, when the monitored temperature value 204B within the apparatus 102 exceeds the first pre-determined temperature threshold value 204A. This may indicate a potential risk of overheating. In such cases, reducing the supply of first green nitrogen from the air supply unit 108 helps mitigate this risk.

At 410, the supply of second green nitrogen may be controlled to terminate the supply of the second green nitrogen from the nitrogen supply unit 106 to the magnetite synthesis unit 112. In an embodiment, the processor 202 may be configured to control the supply of second green nitrogen to terminate the supply of the second green nitrogen from the nitrogen supply unit 106 to the magnetite synthesis unit 112. For example, when the monitored temperature value 204B may be below the first pre-determined temperature threshold value 204A, this indicates that the apparatus 102 is operating within a safe temperature range. In an example, the processor 202 is configured to decrease the supply of second green nitrogen from the nitrogen supply unit 106.

At 412, the supply of the first green nitrogen to terminate the supply of the first nitrogen from the air supply unit 108 to the magnetite synthesis unit 112 may be controlled. In an embodiment, the processor 202 may be configured to control the supply of the first nitrogen to terminate the supply of the first green nitrogen from the air supply unit 108 to the magnetite synthesis unit 112. For example, when the monitored temperature value 204B of at least the first sub-unit within the apparatus falls below the first pre-determined temperature threshold value 204A, this indicates that the apparatus 102 may be operating at a suboptimal temperature that could affect the efficiency of the synthesis reaction.

Accordingly, blocks of the flowchart 400 support combinations of means for performing the specified functions and combinations of operations for performing the specified functions. It will also be understood that one or more blocks of the flowchart 400 and can be implemented by special-purpose hardware-based computer systems which perform the specified functions, or combinations of special-purpose hardware and computer instructions.

Alternatively, the apparatus 102 may include means for performing each of the operations described above. In this regard, according to an example embodiment, examples of means for performing operations may include, for example, the processor 202 and/or a device or circuit for executing the computer program instructions or executing an algorithm for processing information as described above.

FIG. 5 is a flowchart 500 that illustrates an exemplary method for the enhanced production of green hydrogen derivative plants, in accordance with an embodiment of the disclosure. FIG. 5 is explained in conjunction with elements from FIG. 1, FIG. 2, FIG. 3, and FIG. 4. With reference to FIG. 5, there is shown the flowchart 500. The operations of the exemplary method may be executed by an apparatus, for example, the apparatus 102 of FIG. 1 or the processor 202 of FIG. 2. The operations of the flowchart 500 may start at 502.

At 502, a supply of the green hydrogen into the magnetite synthesis unit 112 from the hydrogen supply unit 104 may be controlled. In an embodiment, the processor 202 may be configured to control the supply of the green hydrogen from the hydrogen supply unit 104 to the magnetite synthesis unit 112. For example, the proportional integrated controller 110 may be configured to control the supply of green hydrogen from the hydrogen supply unit 104 to the magnetite synthesis unit 112 based on the predefined green nitrogen-to-green hydrogen ratio. In one or more examples, the predefined ratio of green nitrogen to green hydrogen is 1:3 for the production of green ammonia. Details associated with the controlling of the supply of the green hydrogen from the hydrogen supply unit 104 to the magnetite synthesis unit 112, are provided for example, in FIG. 1, and FIG. 3.

At 504, a supply of the first green nitrogen from the air supply unit 108 to the magnetite synthesis unit 112 may be controlled. The first green nitrogen may be extracted from the air. In an embodiment, the processor 202 may be configured to control the supply of the first green hydrogen from the air supply unit 108 to the magnetite synthesis unit 112. The first green nitrogen may be extracted from the air. For example, various methods of nitrogen extraction including the pressure swing adsorption method, and the membrane separation technique may be used to extract the first green nitrogen from the air. Details associated with controlling the supply of the first green nitrogen from the air supply unit 108 to the magnetite synthesis unit 112, are provided for example, in FIG. 1, and FIG. 3.

At 506, a temperature value of at least a first sub-unit of a set of sub-units may be monitored based on the supply of the first green nitrogen from the air supply unit 108 to the magnetite synthesis unit 112 and the supply of the green hydrogen from the air supply unit 108 to the magnetite synthesis unit 112. In an example, the processor 202 may be configured to monitor the temperature value of at least the first sub-unit of the set of sub-units based on the supply of the first green nitrogen from the air supply unit 108 to the magnetite synthesis unit 112 and the supply of the green hydrogen from the air supply unit 108 to the magnetite synthesis unit 112. For example, the sensors attached to each of the sub-units may be used to monitor the temperature of each of the sub-units and the monitored temperature value 204B of each of the sub-units may be stored in the memory 204 of the apparatus 102. The sensor may provide the real-time temperature of each of the sub-units of the set of sub-units based on the supply of the first green nitrogen and the green hydrogen. Details associated with the monitoring of the temperature value of at least the first sub-unit are provided, for example, in FIG. 1, and FIG. 3.

At 508, the monitored temperature value 204B of the first sub-unit of the set of sub-units may be compared with the first pre-determined temperature threshold value 204A. In an embodiment, the processor 202 may be configured to compare the monitored temperature value 204B of the first sub-unit of the set of sub-units with the first pre-determined temperature threshold value 204A. For example, the first pre-determined temperature threshold value 204A for the magnetite synthesis unit 112 to function efficiently may be close to 1200 degrees Celsius. Details associated with the comparison of the monitored temperature value 204B and the first pre-determined temperature threshold value 204A are provided, for example, in FIG. 1, and FIG. 3.

At 510, a supply of the second green nitrogen from the nitrogen supply unit 106 to the magnetite synthesis unit 112 may be controlled based on the comparison, to maintain a predefined ratio of nitrogen-to-hydrogen in the magnetite synthesis unit 112. In an embodiment, the processor 202 may be configured to control the supply of the second green nitrogen from the nitrogen supply unit 106 to the magnetite synthesis unit 112 may be controlled based on the comparison, to maintain a predefined ratio of nitrogen-to-hydrogen in the magnetite synthesis unit 112. For example, the second green nitrogen from the nitrogen supply unit 106 may be supplied to the magnetite synthesis unit 112 when the ratio of the first green nitrogen to hydrogen falls below the predefined ratio or when the temperature of at least the first sub-unit of the set of sub-units may exceed the corresponding pre-determined threshold value. The supply of second green nitrogen may ensure that the nitrogen-to-green hydrogen ratio remains within the desired ratio. For example, the predefined ratio may be 1:3 for the production of green ammonia. Details associated with controlling the supply of the second green nitrogen from the nitrogen supply unit 106 to the magnetite synthesis unit 112, are provided for example, in FIG. 1, and FIG. 3.

Accordingly, blocks of the flowchart 500 support combinations of means for performing the specified functions and combinations of operations for performing the specified functions. It will also be understood that one or more blocks of the flowchart 500 can be implemented by special-purpose hardware-based computer systems which perform the specified functions, or combinations of special-purpose hardware and computer instructions.

Alternatively, the apparatus 102 may include means for performing each of the operations described above. In this regard, according to an example embodiment, examples of means for performing operations may include, for example, the processor 202 and/or a device or circuit for executing the computer program instructions or executing an algorithm for processing information as described above.

Various embodiments of the disclosure may provide a non-transitory computer readable medium having stored thereon computer executable instructions, which when executed by one or more processors (such as the processor 202), cause the one or more processors to carry out operations to operate an apparatus (e.g., the apparatus 102). The instructions may cause the machine and/or computer to perform operations including controlling a supply of green hydrogen from the hydrogen supply unit 104 to the magnetite synthesis unit 112 and controlling a supply of first green nitrogen from the air supply unit 108 to the magnetite synthesis unit 112. The first green nitrogen may be extracted from the air. The operations may further include monitoring a temperature value of at least a first sub-unit of a set of sub-units based on the supply of the first green nitrogen to the magnetite synthesis unit 112 and the supply of the green hydrogen to the magnetite synthesis unit 112. The operations may further include comparing the monitored temperature value of at least the first sub-unit of the set of sub-units with a first pre-determined temperature threshold value. The operations may further include controlling a supply of second green nitrogen from the nitrogen supply unit 106 to the magnetite synthesis unit based on the comparison, to maintain a predefined ratio of nitrogen-to-hydrogen in the magnetite synthesis unit 112.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of reactants and/or functions, it should be appreciated that different combinations of reactants and/or functions may be provided by alternative embodiments without departing from the scope of the appended claims. In this regard, for example, different combinations of reactants and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising:
at least one non-transitory memory configured to store computer-executable instructions; and
at least one processor configured to execute the computer-executable instructions to:
control a supply of green hydrogen from a hydrogen supply unit to a magnetite synthesis unit;
control a supply of first green nitrogen from an air supply unit to the magnetite synthesis unit, wherein the first green nitrogen is extracted from air;
monitor a temperature value of at least a first sub-unit of a set of sub-units based on the supply of the first green nitrogen from the air supply unit to the magnetite synthesis unit and the supply of the green hydrogen from the hydrogen supply unit to the magnetite synthesis unit;
compare the monitored temperature value of at least the first sub-unit of the set of sub-units with a first pre-determined temperature threshold value; and
control a supply of second green nitrogen from a nitrogen supply unit to the magnetite synthesis unit based on the comparison, to maintain a predefined ratio of nitrogen-to-hydrogen in the magnetite synthesis unit.

2. The apparatus of claim 1, wherein the set of sub-units comprise at least: a primary reformer unit, a secondary reformer unit, a shift and carbon dioxide removal unit, a methanation and dryer unit, a compression unit, the magnetite synthesis unit, a purge gas recovery unit, or a green hydrogen derivatives unit.

3. The apparatus of claim 1, wherein the processor is further configured to execute the computer-executable instructions to control the supply of the green hydrogen from the hydrogen supply unit to the magnetite synthesis unit based on the comparison to maintain the predefined ratio of the green nitrogen and the green hydrogen in the magnetite synthesis unit.

4. The apparatus of claim 1, wherein the processor is further configured to execute the computer-executable instructions to:
generate a feedback signal based on the comparison of the monitored temperature value with the first pre-determined temperature threshold value; and
control the supply of the green hydrogen from the hydrogen supply unit to the magnetite synthesis unit, the supply of the first green nitrogen from the air supply unit to the magnetite synthesis unit and control the supply of the second green nitrogen from the nitrogen supply unit to the magnetite synthesis unit based on the generated feedback signal.

5. The apparatus of claim 4, wherein the processor is further configured to execute the computer-executable instructions to control a proportion integrated controller (PIC) to receive the generated feedback signal, and wherein the air supply unit is integrated with the PIC.

6. The apparatus of claim 4, wherein the processor is further configured to execute the computer-executable instructions to, responsive to the monitored temperature value of at least the first sub-unit of the set of sub-units being greater than the first pre-determined temperature threshold value:
control the supply of the second green nitrogen from the nitrogen supply unit to the magnetite synthesis unit; and
control the supply of the first green nitrogen from the air supply unit to the magnetite synthesis unit.

7. The apparatus of claim 4, wherein the processor is further configured to execute the computer-executable instructions to, responsive to the monitored temperature value of at least the first sub-unit of the set of sub-units being less than the first pre-determined temperature threshold value:
control the supply of the second green nitrogen to terminate the supply of the second green nitrogen from the nitrogen supply unit to the magnetite synthesis unit; and
control the supply of the first green nitrogen to terminate the supply of the first green nitrogen from the air supply unit to the magnetite synthesis unit.

8. The apparatus of claim 1, wherein the hydrogen supply unit corresponds to an electrolyzer unit.

9. The apparatus of claim 8, wherein the processor is further configured to execute the computer-executable instructions to control the hydrogen supply unit to receive water and split the water into the green hydrogen and green oxygen at an electrolyzing temperature.

10. The apparatus of claim 1, wherein the predefined ratio of green nitrogen to the green hydrogen is 1:3.

11. The apparatus of claim 1, wherein the green nitrogen and the green hydrogen are used for production of green ammonia, and wherein the green nitrogen and the green hydrogen are present in the predefined ratio.

12. The apparatus of claim 11, the processor is further configured to execute the computer-executable instructions to regulate the ratio of the green nitrogen and the green hydrogen to match the predefined ratio in the magnetite synthesis unit using a proportion integrated controller (PIC).

13. A method comprising:
controlling a supply of green hydrogen from a hydrogen supply unit to a magnetite synthesis unit;
controlling a supply of first green nitrogen from an air supply unit to the magnetite synthesis unit, wherein the first green nitrogen is extracted from air;
monitoring a temperature value of at least a first sub-unit of a set of sub-units based on the supply of the first green nitrogen from the air supply unit to the magnetite synthesis unit and the supply of the green hydrogen from the hydrogen supply unit to the magnetite synthesis unit;
comparing the monitored temperature value of at least the first sub-unit of the set of sub-units with a first pre-determined temperature threshold value; and
controlling a supply of second green nitrogen from a nitrogen supply unit to the magnetite synthesis unit based on the comparison, to maintain a predefined ratio of nitrogen-to-hydrogen in the magnetite synthesis unit.

14. The method of claim 13, wherein the set of sub-units comprise at least: a primary reformer unit, a secondary reformer unit, a shift and carbon dioxide removal unit, a methanation and dryer unit, a compression unit, the magnetite synthesis unit, a purge gas recovery unit, or a green hydrogen derivatives unit.

15. The method of claim 13, further comprising controlling the supply of the green hydrogen from the hydrogen supply unit to the magnetite synthesis unit based on the comparison to maintain the predefined ratio of the green nitrogen and the green hydrogen in the magnetite synthesis unit.

16. The method of claim 13, further comprising:
generating a feedback signal based on the comparison of the monitored temperature value with the first pre-determined temperature threshold value; and
controlling the supply of the green hydrogen from the hydrogen supply unit to the magnetite synthesis unit, the supply of the first green nitrogen from the air supply unit to the magnetite synthesis unit, and the supply of the second green nitrogen from the nitrogen supply unit to the magnetite synthesis unit based on the generated feedback signal.

17. The method of claim 16, the method further comprising controlling a proportion integrated controller (PIC) to receive the generated feedback signal, and wherein the air supply unit is integrated with the proportion integrated controller (PIC).

18. The method of claim 16, wherein the monitored temperature value of the at least the first sub-unit of the set of the sub-units being greater than the first pre-determined temperature threshold value, the method further comprising:
controlling the supply of the second green nitrogen from the nitrogen supply unit to the magnetite synthesis unit; and
controlling the supply of the first green nitrogen from the air supply unit to the magnetite synthesis unit.

19. The method of claim 16, wherein the monitored temperature value of at least the first sub-unit of the set of sub-units being less than the first pre-determined temperature threshold value, the method further comprising:
controlling the supply of the second green nitrogen to terminate the supply of the second green nitrogen from the nitrogen supply unit to the magnetite synthesis unit; and
controlling the supply of the first green nitrogen to terminate the supply of the first green nitrogen from the air supply unit to the magnetite synthesis unit.

20. A non-transitory computer-readable medium having stored thereon, computer-executable instructions that when executed by a processor of an apparatus, causes the processor to execute operations, the operations comprising:
controlling a supply of green hydrogen from a hydrogen supply unit to a magnetite synthesis unit;
controlling a supply of first green nitrogen from an air supply unit to the magnetite synthesis unit, wherein the first green nitrogen is extracted from air;
monitoring a temperature value of at least a first sub-unit of a set of sub-units based on the supply of the first green nitrogen to the magnetite synthesis unit and the supply of the green hydrogen to the magnetite synthesis unit;
comparing the monitored temperature value of at least the first sub-unit of the set of sub-units with a first pre-determined temperature threshold value; and
controlling a supply of second green nitrogen from a nitrogen supply unit to the magnetite synthesis unit based on the comparison, to maintain a predefined ratio of nitrogen-to-hydrogen in the magnetite synthesis unit.
